(19) United States
(12) Patent Application Publication
(10) Pub. No.: US 2003/0135395 A1
(43) Pub. Date: Jul. 17, 2003

(54) System and methods for performing financial analysis of proposed captive reinsurance options

(76) Inventors: Timothy M. Carfi, Sandy Hook, CT (US); Scott Hammond, Raleigh, NC (US)

Correspondence Address: PRIEST & GOLDSTEIN PLLC, 5015 SOUTHPARK DRIVE, SUITE 230, DURHAM, NC, 27713-7736, US

(21) Appl. No.: 09/683,515

(22) Filed: Jan. 11, 2002

(51) Int. Cl. G06F 17/60

(52) U.S. Cl. 705/4

(57) ABSTRACT

Various systems and methods are described for performing a financial analysis of proposed captive reinsurance options. One described system includes a server computer and at least one terminal connected into a network with the server computer. The terminal receives inputs from, and provides outputs to, a user. A software module run by the server computer for performs a financial analysis of proposed captive reinsurance options based upon inputs received at the terminal from a user, including reinsurance structure, type of reinsurance, net premium cede, new insurance written and portfolio loan-to-value mix. The results of the financial analysis are displayed to the user at the terminal. In a further described system, the user explores alternative scenarios by inputting adjustments to assumptions used by the software module in performing the financial analysis.

### BACKGROUND OF INVENTION

The present invention relates generally to improvements to systems and methods for financially analyzing reinsurance options, and more particularly to advantageous aspects of systems and methods for performing a financial analysis of a proposed captive reinsurance structure.

It may be advantageous for a mortgage insurance customer to modify their current mortgage reinsurance coverage through the use of an enhanced captive reinsurance structure. At present, it is typically not an easy matter for a customer to make this determination. There are a couple of reasons for this. First, the customer may not have ready access to relevant product data. Second, the customer may not know how to analyze product data in light of the customer's current financial situation to arrive at a proper determination as to whether a captive reinsurance structure should be considered. Thus, customers may be missing out on advantageous opportunities.

### SUMMARY OF INVENTION

Various aspects of the present invention provide systems and methods for performing a financial analysis of proposed captive reinsurance options. One system according to the invention includes a server computer and at least one terminal connected into a network with the server computer. The terminal receives inputs from, and provides outputs to, a user. A software module run by the server computer performs a financial analysis of proposed captive reinsurance options based upon inputs received at the terminal from a user, including reinsurance structure, type of reinsurance, net premium cede, new insurance written and portfolio loan-to-value mix. The results of the financial analysis are displayed to the user at the terminal. According to a further aspect of the invention, the user explores alternative scenarios by inputting adjustments to assumptions used by the software module in performing the financial analysis.

Additional features and advantages of the present invention will become apparent by reference to the following detailed description and accompanying drawings.

### BRIEF DESCRIPTION OF DRAWINGS

FIG. 1 shows a diagram of a system according to an aspect of the invention.

FIG. 2 shows a diagram mapping information flow according to an aspect of the invention.

FIG. 3 shows a website home screen according to an aspect of the invention.

FIG. 4 shows a main menu screen according to an aspect of the invention.

FIG. 5 shows the main menu screen of FIG. 4 with a sub-menu displayed.

FIGS. 6A and 6B show a Captive Reinsurance Wizard home screen according to an aspect of the invention.

FIG. 7 shows an input screen according to an aspect of the invention.

FIG. 8 shows a results screen according to an aspect of the invention.

FIGS. 9A and 9B show a details screen according to an aspect of the invention.

FIG. 10 shows a flowchart of a method according to an aspect of the invention.

### DETAILED DESCRIPTION

Mortgage insurance is a type of insurance in which a mortgage insurance company insures a mortgage investor against losses arising from a default by a mortgage borrower. The mortgage insurance company may in turn enter into a reinsurance arrangement with a reinsurer, whereby the reinsurer, in consideration of premiums paid by the mortgage insurance company to the reinsurer, agrees to indemnify the mortgage insurance company for part or all of the liability assumed by the mortgage insurance company under a policy or policies of mortgage insurance.

It may be advantageous under certain circumstances for a mortgage lender who has originated an insured loan to use a lender-affiliated reinsurer or sponsored captive to reinsure part of the risk insured by the mortgage insurance company. In this case, the mortgage lender continues to forward premiums to the mortgage insurance company. The mortgage insurance company, in turn, pays a portion of the mortgage insurance premiums to the lender-affiliated reinsurer or sponsored captive, sometimes retaining a commission to defray administrative expenses. Profits and losses are shared between the insurer and the reinsurer based upon loan performance. If an insured loss occurs, and a payment is to be made under the mortgage insurance policy, the loss is allocated between the insurance company and the lender-affiliated reinsurer or sponsored captive pursuant to the terms of the contract of reinsurance.

In order to make an intelligent decision as to whether to enter into a reinsurance arrangement, an insured mortgage lender must consider a number of factors, including the projected income and return on equity of such a venture. One aspect of the present invention provides systems and methods for performing a financial analysis of a proposed captive reinsurance structure.

Before proceeding to a more detailed discussion of the present invention, the following definitions are provided:

“Aggregate Risk”—For each book of covered business, the “aggregate risk” is an amount equal to the sum of risks insured with respect to the reinsured loans within that book.

“Aggregate Risk Exposure”—For each book of covered business, the “aggregate risk exposure” is an amount equal to a percentage of the sum of the risks insured for each book.

“Attachment Points” refer to points defining the beginning and ending of a reinsurer's risk, and establish the bandwidth within the reinsurance structure. Attachment points are usually defined as a percentage of the total insurance or risk in force.

“Bandwidth” refers to the amount of risk that a reinsurer assumes expressed as a percent of the aggregate risk. For example, a bandwidth may be 5% to 10% of aggregate risk.

“Book” or “Book of Covered Business” refers to all policies issued for a specific period, typically the insurer's fiscal year, with respect to the reinsured loans to which the company has received the first premium payment, or notice of payment for a “zero monthly” product.

“Capital Ratio” refers to the ratio, expressed as a percentage, of the insurer's capital reserves to the aggregate risk exposure.

“Capital Requirement Amount” refers, for each book of covered business, to all reinsurer reserves plus the greater of (a) a capital ratio that is at least 10% and (b) equal to a contingency reserve equal to 50% of the aggregate earned premiums with respect to the previous 10 books of covered business.

“Cede”—In the event that a company reinsures its liability with another, it is said to have “ceded” the reinsured portion of its business. In a captive mortgage reinsurance structure, the mortgage insurer is referred to as the “cedent” or “ceding company.” The term “cede” also refers to the act of transferring a portion of mortgage insurance premiums to a reinsurer.

“Ceding Commission” refers to a commission paid by a reinsurer to a ceding company in order to reimburse expenses associated with the ceded business.

“Claim Payment”—With respect to a reinsured loan, the term “claim payment” refers to the amount that is actually paid by the mortgage insurance to the insured for a covered loss as required by the applicable mortgage insurance policy.

“Claims Termination Rate (CTR)” refers to the number of loans within a book of covered business that go to claim, expressed as a percentage.

“Excess of Loss” refers to a type of reinsurance structure in which the reinsurer is responsible for the payment of losses once they exceed an amount as specified within the agreement and up to an amount as specified within the agreement.

“Gross Premium Cede” refers to the percentage of premiums ceded to reinsurer before figuring in a ceding commission for expenses.

“Gross Written Premium”—With respect to reinsured loans, the term “gross written premium” refers to premiums received by the ceding company, less cancellations and returns.

“Insurance in Force” refers to the amount, at any given time, of the then-unpaid principal balance of a reinsured loan.

“Loss”—A loss is deemed to have occurred, or to have been incurred, as of the date when a default occurs, notwithstanding that the amount of the loss is neither ascertainable nor due and payable as of such date.

“New Reinsurance Written” refers to the dollar value of loans generated with primary mortgage insurance.

“Pretax Investment Rate” refers to the rate of return on capital held in trust.

“PSA” or “PSA Prepayment Speed” refers to a measure of the rate of prepayment of mortgage loans developed by the Public Securities Association, a national trade association of banks, dealers, and brokers that underwrite, trade, and distribute mortgage-backed securities, U.S. government and federal agency securities, and municipal securities. The PSA model represents an assumed rate of prepayment each month of the then-outstanding principal balance of a pool of new mortgage loans. A 100 percent PSA assumes prepayment rates of 0.2 percent per annum of the then unpaid principal balance of mortgage loans in the first month after origination and an increase of an additional 0.2 percent per annum in each month thereafter, for example, 0.4 percent per annum in the second month, until the 30th month. Beginning in the 30th month and in each month thereafter, 100 percent PSA assumes a constant annual prepayment rate of 6 percent. Multiples are calculated from this prepayment rate. For example, 150 percent PSA assumes annual prepayment rates will be 0.3 percent in month one, 0.6 percent in month two, reaching 9 percent in month 30, and remaining constant at 9 percent thereafter. A zero percent PSA assumes no prepayments.

“Quota Share” refers to a reinsurance structure whereby a reinsurer accepts a stated percentage of each and every risk, as specified within the agreement.

“Single Parent (Domestic)” refers to a reinsurance company that is established as a single entity, domiciled within the United States. In a single parent domestic structure, also referred to as a “single parent onshore,” a captive reinsurance company, domiciled in the United States, is formed and owned by a lender, or parent, with the sole purpose of reinsuring the risk of loans that are originated or purchased by the lender.

“Single Parent (Offshore)” refers to a reinsurance company that is domiciled outside of the United States. A single parent offshore structure is similar to a single parent domestic structure. However, the captive insurance company is domiciled in an international location, typically where certain tax benefits may be realized, such as Bermuda, the Cayman Islands, the Turks and Caicos Islands, or the like. An offshore captive cannot be formed by an entity that is regulated by the Office of the Comptroller of the Currency (OCC) or the Office of Thrift Supervision (OTS).

“Sponsored Captive” refers to a reinsurance structure that is established by a single entity, for utilization by multiple parties located within individual protected cells within the reinsurance structure. In a sponsored captive structure, a lender purchases a “protected cell” within a captive that has already been set up by another entity, such as the mortgage insurer, as opposed to taking their own equity position in a captive. The cell is completely segregated from other cells, so that there is no overlap of performance issues from one to another. This structure is considered to be beneficial because of the reduced expense and ease of entry.

“Trust Account” refers to an account that is to be established with a third party trustee that is for the benefit of the mortgage insurer with respect to the liabilities due itself.

Aspects of the present invention provide systems and methods, collectively referred to herein as the “Lender Captive Wizard” or the “Captive Reinsurance Wizard,” that provide a lender with a specific analysis of financial performance that may be achievable using a captive reinsurance structure. As used herein, the term “system” refers to hardware, software, or any combination thereof. The system described herein may be implemented on standard, general-purpose computers or utilizing specialized devices. According to one aspect of the invention, the Lender Captive Wizard comprises software that is run on a central server computer. The server computer is connected to a network of terminals, each of which may be a stand-alone personal computer or workstation.

The Lender Captive Wizard is a web-based tool that enables a mortgage lender, hereinafter referred to as a “customer,” to assess the potential risks and rewards of captive reinsurance. The Wizard also allows the customer to evaluate the profit-and-loss potential of captive reinsurance under a variety of scenarios, involving: different captive types, including single parent domestic, sponsored, and single parent offshore; different reinsurance structures, including excess of loss and quota share; various amounts of premiums and risk ceded; various portfolio LTV mixes; and various prepayment speeds and investment yields. Based upon the inputs, the Captive Reinsurance Wizard calculates a ten-year pro forma income and loss statement. By varying the inputs and assumptions, the customer may generate income and loss statements for a number of different scenarios. It should be noted that, although it is contemplated that the present invention will be used primarily by customers, the present invention may also be made available to other users to perform a financial analysis of captive reinsurance options.

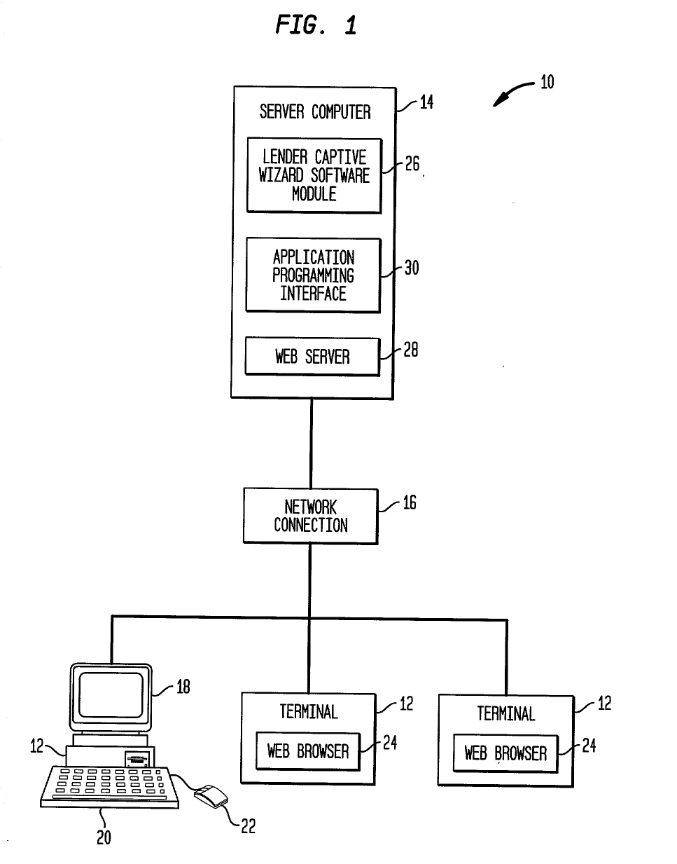

FIG. 1 shows a diagram of a system 10 according to an aspect of the invention. The system 10 includes a network of terminals 12 that are connected to a server computer 14 using a network connection 16. The network connection 16 may be an Internet connection, or may be part of a local area network. Each terminal 12 includes input and output devices for receiving inputs from, and providing outputs to, customers using the system 10. These devices may include a monitor 18, a keyboard 20, and a mouse 22. Other devices may be used, as desired. In addition, a printer (not shown) may be used to print out results of the financial analysis. The terminals 12 may be provided by a stand-alone personal computer, but may also be provided by other devices, including workstations and personal digital assistants. Each terminal runs a suitable web browser 24, such as Microsoft Internet Explorer™ or Netscape Navigator™.

The server computer 14 runs a Lender Captive Wizard software module 26 that performs a financial analysis of proposed captive reinsurance options, as described below. The software module 26 incorporates product information and certain financial assumptions, which are used to perform the financial analysis. According to an aspect of the invention, it is contemplated that the software module 26 will be updated on a regular basis, such as quarterly or annually, to reflect changes in product information or the financial assumptions used in performing the analysis.

The server computer 14 runs a web server 28 for serving web pages that are transmitted to terminals 12 for display. The web pages are generated using data from the Lender Captive Wizard software module 26. Because the server computer 14 may be running a number of different software applications, the server computer 14 includes a suitable applications programming interface (API) 30.

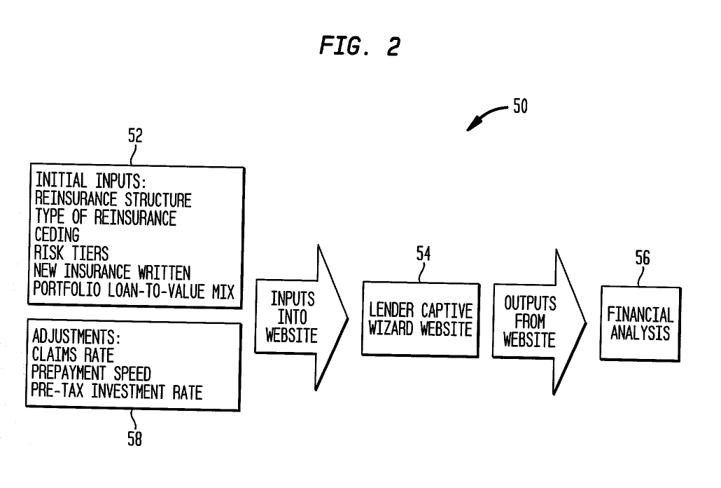

FIG. 2 shows a diagram mapping information flow 50 according to an aspect of the invention. As shown in FIG. 2, a customer using the system provides certain initial inputs 52 into the system, including: reinsurance structure, type of reinsurance, ceding, new insurance written, and portfolio LTV mix. As described below, these items may be inputted into the system through a website that is accessed by the customer. The website then provides as an output a financial analysis 58. As described below, according to an aspect of the invention, the financial analysis 58 may include a financial summary, as well as a more detailed year-by-year analysis. After the customer has received the financial analysis 58, the customer may input adjustments 60 to certain parameters used by the system in performing the financial analysis, including claims rate, prepayment speed, and pre-tax investment rate. The customer then receives a modified financial analysis 58.

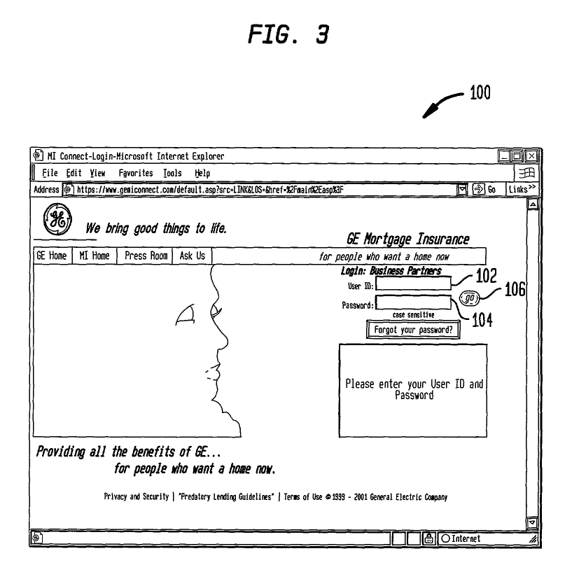

As mentioned above, according to an aspect of the invention, the Lender Captive Wizard is accessed through a website. FIG. 3 shows a main website screen 100 according to an aspect of the invention. As used herein, the term “screen” is used interchangeably with the term “web page.” According to an aspect of the invention, the website provides access to a number of different analytical tools, including the Lender Captive Wizard. The customer enters a user identifier (ID) 102 and password 104 and clicks on the Go button 106.

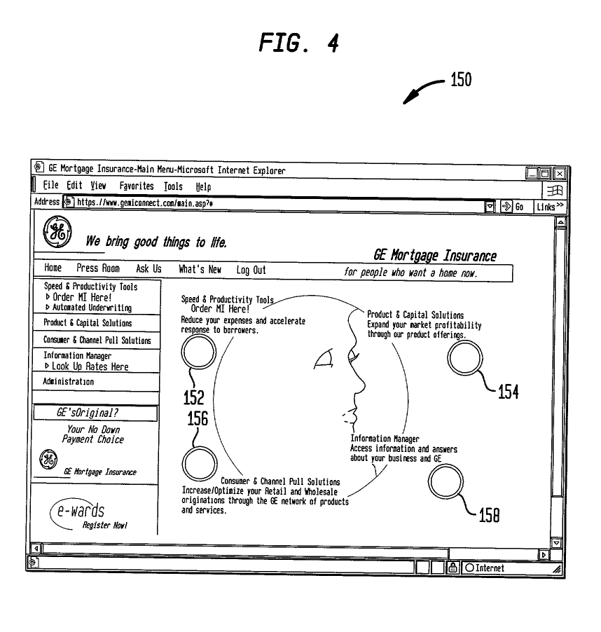

FIG. 4 shows a main menu screen 150 according to an aspect of the invention. The main menu page 150 is the screen that is displayed after the customer has entered a valid user ID and password. As shown in FIG. 4, the screen 150 includes a number of selections, including a number of sub-menus that are accessed using the following buttons: Speed and Productivity Tools 152, Product and Capital Solutions 154, Consumer and Channel Pull Solutions 156, and Information Manager 158.

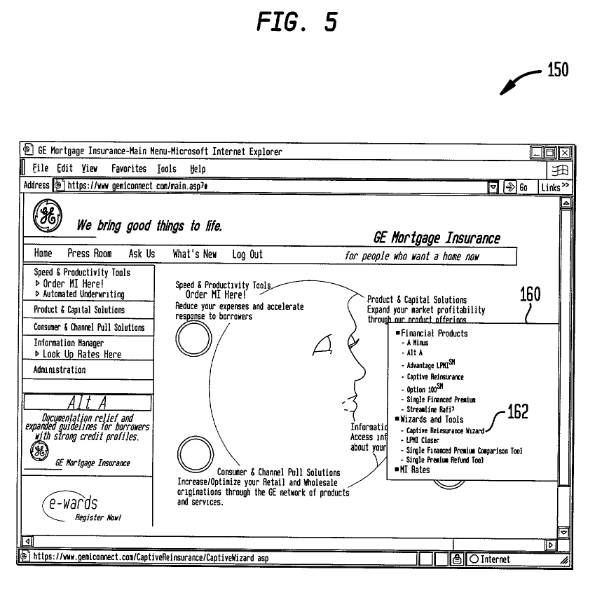

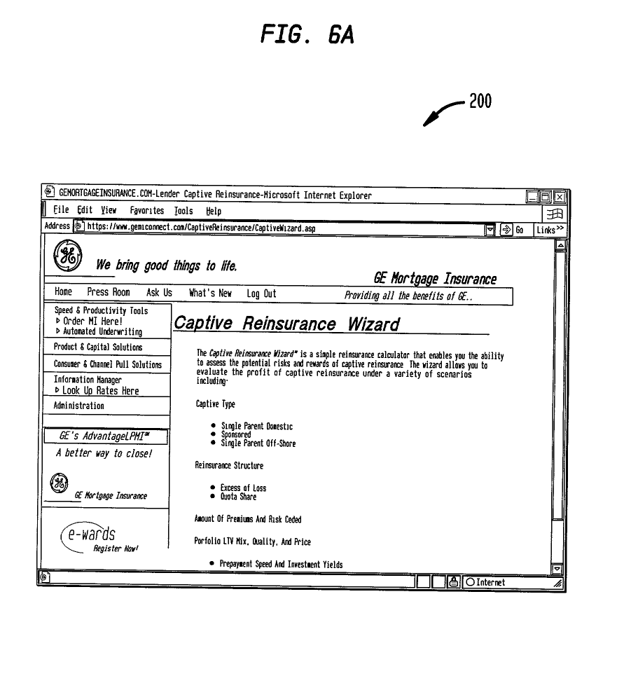

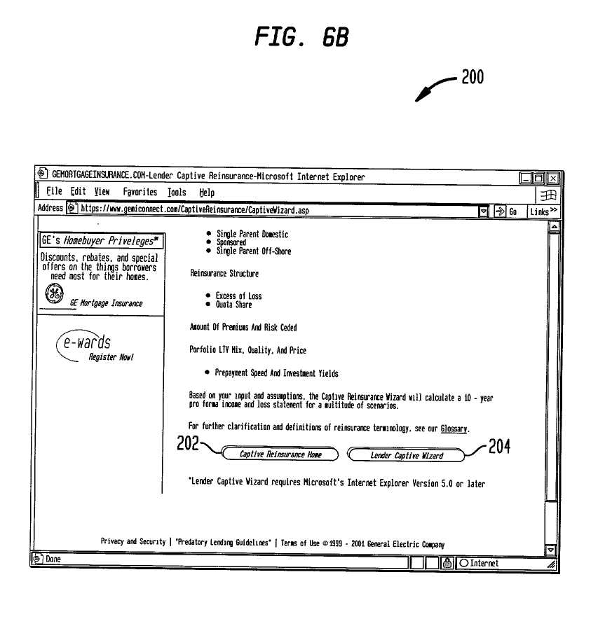

FIG. 5 shows a sub-menu 160 that appears if the customer clicks on the button labeled Product and Capital Solutions 154. The sub-menu 160 includes a number of selections, including Captive Reinsurance Wizard 162. Selecting this item 162 takes the customer to the Captive Reinsurance Wizard home screen 200, shown in FIGS. 6A and 6B.

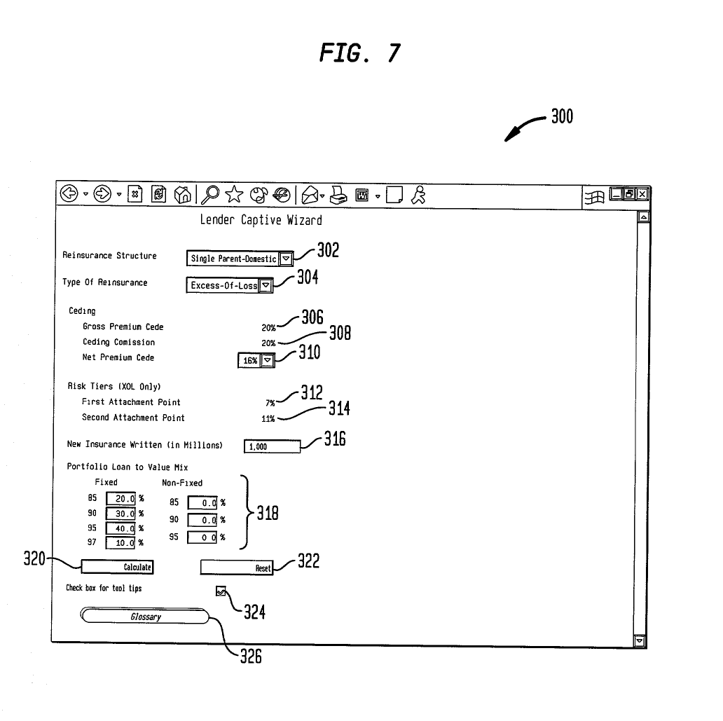

The Captive Reinsurance Wizard home screen 200 displays text that provides the customer with a general introduction to captive reinsurance. At the bottom of the screen 200, there are displayed two buttons: Captive Reinsurance Home 202 and Lender Captive Wizard 204. Clicking on the Captive Reinsurance Home button 202 transfers the customer to a screen (not shown) that describes captive reinsurance products in greater detail. Clicking on the Lender Captive Wizard 204 transfers the customer to the Lender Captive Wizard input screen 300, shown in FIG. 7.

As shown in FIG. 7, the input screen 300 requires relatively few inputs from the customer. The customer first inputs a reinsurance structure 302 by making a selection from a dropdown menu including the following options: single parent domestic; single parent offshore; and sponsored. The customer then inputs a type of reinsurance 304 by making a selection from a dropdown menu including the following options: excess-of-loss and quota share. The customer then inputs a net premium cede 310 by making a selection from a dropdown menu including the following selections: 16%, 20% and 25%.

Based upon the selected net premium cede 310, the system then automatically calculates and displays a Gross Premium Cede 306 and a Ceding Commission 308. In addition, if the customer has inputted excess-of-loss (XOL) as the Type of Reinsurance 304, the system also automatically displays Risk Tiers, including a First Attachment Point 312 and a Second Attachment Point 314.

The customer enters an estimate of the amount of New Insurance Written (in Millions) 316. In addition, the customer inputs a Portfolio Loan to Value Mix. As shown in FIG. 7, the calculator screen 300 includes a matrix of seven boxes 318, each of which represents an LTV category: 85 (fixed mortgage), 90 (fixed mortgage), 95 (fixed mortgage), 97 (fixed mortgage), 85 (non-fixed mortgage), 90 (non-fixed mortgage), and 95 (non-fixed mortgage). The customer determines the dollar-value percentages of mortgages in the portfolio falling under each of these categories and inputs the percentages in the matrix 318. The percentages entered into the matrix 318 must add up to 100 percent. If they do not, the calculator screen 300 displays an error message when the Calculate button 320 is pressed.

The system further provides tool tips, which are text boxes that are displayed when the customer points the cursor at the labels for various data entry boxes. For example, if the customer has selected “Single Parent Domestic” in the Reinsurance Structure 302, and points the cursor at the label “Reinsurance Structure,” a text box appears defining single parent domestic reinsurance. If the customer does not wish the tool tips to be displayed, the customer clicks on the tool tips checkbox 324, causing the box to be unchecked.

If the customer wishes definitions of any terms used by the lender captive wizard, the customer clicks on the Glossary button 326 at the bottom of the screen. This causes a Glossary screen to be displayed.

When the calculator screen 300 is first accessed, all of the data entry boxes are populated with default values, representing typical values for a hypothetical mortgage lender. If, after entering values into the various fields, the customer wishes to return to the default values, the customer clicks on the Reset button 322.

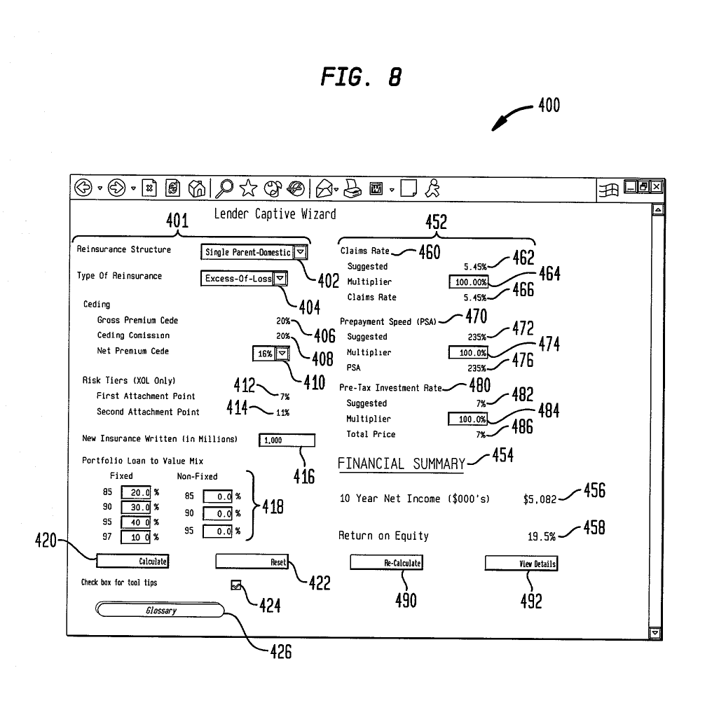

When the customer has completed inputting information into the various fields described above, the customer clicks on the Calculate button 320. This causes the system to automatically perform an analysis based upon the inputted data. The results of the calculation are displayed on a results screen 400, shown in FIG. 8. The results screen 400 is similar to the input screen 300 shown in FIG. 7, but includes a second column 450 at the right of the screen 400. At the bottom of the second column 450, under the heading Financial Summary 454, there are displayed a 10-Year Net Income (in thousands) 456 and a Return on Equity 458.

Above the Financial Summary 454 are displayed some of the assumptions that were used by the system in arriving at the 10-Year Net Income 456 and the Return on Equity 458. These assumptions include: claims Rate 460, Prepayment Speed (PSA) 470, and Pre-Tax Investment Rate 480. For each of these assumptions, there is displayed a suggested value 462, 472 and 482, which is the value that was used by the system in making its initial calculation. Underneath each suggest values 462, 472 and 482, is a data entry box for receiving a multiplier 464, 474 and 484. The multiplier 464, 474 and 484 is automatically multiplied to the suggested values 462, 472 and 482 to arrive at a total claims rate 466, PSA 476 and investment rate 486. The use of the multipliers is discussed below.

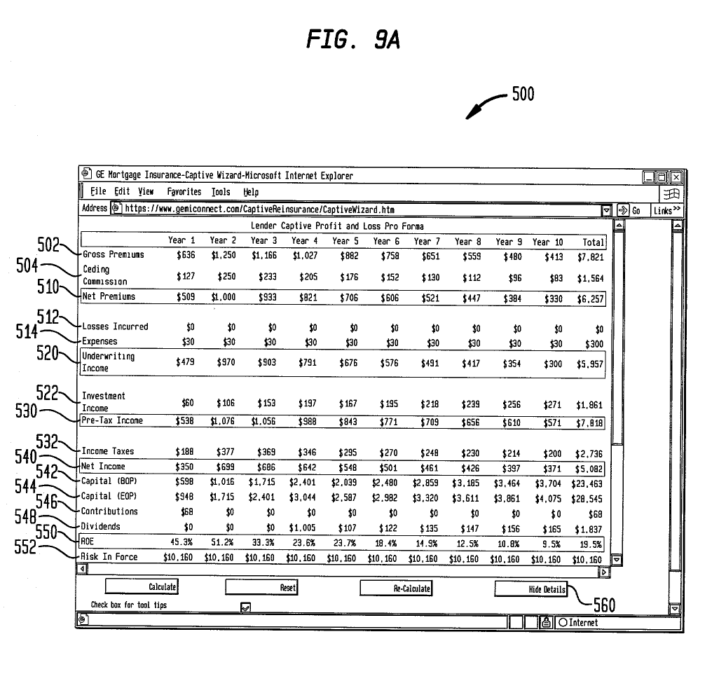

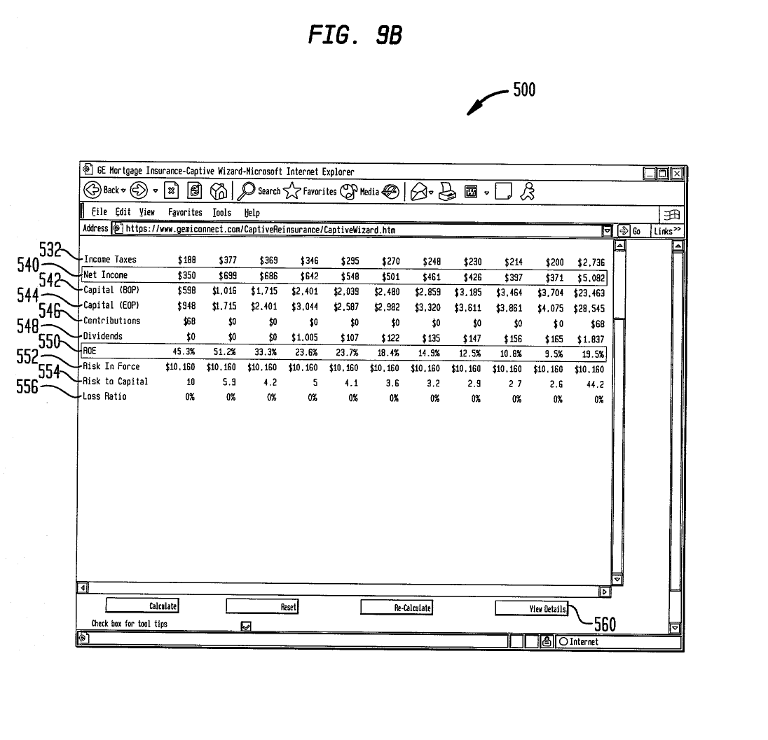

If the customer wishes to see additional detail for any of the scenarios, the customer clicks on the View Details button 492 at the bottom right of the enhanced calculator screen 400. This causes the details screen 500, shown in FIGS. 9A and 9B, to be displayed. The details screen provides a ten-year projection of profits and losses, based upon the assumptions and data entered into the calculator screen.

The details screen 500 includes ten columns for each of the first ten years, and a column displaying the total profit and loss for the ten years. Five rows of the table are highlighted for convenient reference: Net Premiums 510, Underwriting Income 520, Pre-Tax Income 530, Net Income 540, and Return on Equity 550. The details screen is populated by the system as follows:

Gross Premiums 502: Estimated by the system using current premium rates, based upon the information inputted in FIG. 8. The Prepayment Speed (PSA) 470 shown in FIG. 8 has an effect on gross premiums over the analyzed ten-year period. A higher PSA results in less premiums in later years, thereby resulting in less income and a lower return on equity.

Ceding Commission 504: Calculated by the system by multiplying the gross premiums 502 by the ceding commission 408 displayed in Fig.

Net Premiums 510: Calculated by the system by subtracting the ceding commission 504 from the gross premiums 502.

Losses Incurred 512: Estimated by the system using the claims Rate 460 displayed in FIG. 8, and based upon the other information inputted by the customer in Fig.

Expenses 514: Estimated by the system using current expense ratios, based upon the information inputted in FIG. 8.

Underwriting Income 520: Calculated by the system by subtracting Losses Incurred 512 and Expenses 514 from Net Premiums 510.

Investment Income 522: Calculated by the system using the Pre-Tax Investment Rate 480 displayed in FIG. 8 based upon the average amount of capital held in trust for the year. The amount of capital held in trust is dictated by capital requirements, discussed below.

Pre-Tax Income 530: Calculated by the system by adding Underwriting Income 520 and Investment Income 522.

Income Taxes 532: Determined by the system using current tax tables, based upon the amount of Pre-Tax Income 530.

Net Income 540: Determined by the system by subtracting Income Taxes 532 from Pre-Tax Income 530.

Capital, Beginning of Period (BOP) 542: Initial capital requirements are based upon the Risk in Force 552, and the Risk to Capital Ratio 554, discussed below.

Capital, End of Period (EOP) 544: Computed by the system by adding to the Capital (BOP) the Net Income 540 and any Contributions to Capital 546, and subtracting any Dividends 548 paid out during the year.

Contributions 546: Amounts determined by the system that must be added to Capital (BOP) to maintain the required Risk to Capital Ratio 554.

Dividends 548: The system assumes that any amounts of capital over the amount required to maintain the required Risk to Capital Ration 554 are paid out as dividends.

Return on Equity (ROE) 550: Computed by the system by dividing the Net Income 540 by the average between Capital (BOP) 542 and Capital (EOP) 544.

Risk in Force 552: Determined by the system based upon the various inputs in FIG. 8.

Risk to Capital Ratio 554: Required ration between Risk in Force 552 and capital in trust.

Loss Ratio 556: Industry average for reinsurance corresponding to inputs in FIGS. 7 and 8.

Returning to the results screen 400 shown in FIG. 8, if the customer wishes to adjust any or all of the suggested values 462, 472 and 482, the customer enters a multiplier 464, 474 and 484 in a box under the suggested value to be adjusted. The multiplier is a percentage, which can be less than or greater than 100 percent. When a multiplier is entered, the system then automatically displays the adjusted value 466, 476 and 486 underneath the multiplier.

After the customer has adjusted the suggested values by inputting multipliers, the customer clicks on the Re-Calculate button 490, and the system automatically performs a recalculation, displaying the results of the recalculation under the heading Financial Summary 454. The customer may also adjust the inputted values by changing one of the inputs in the left column of the screen 400: Reinsurance Structure, Type of Reinsurance, Net Premium Cede, New Insurance Written, and Portfolio LTV Mix. Changing one of these values causes the system to automatically revert to the screen 300 shown in FIG. 7. The customer may recalculate as many times as desired to explore different scenarios.

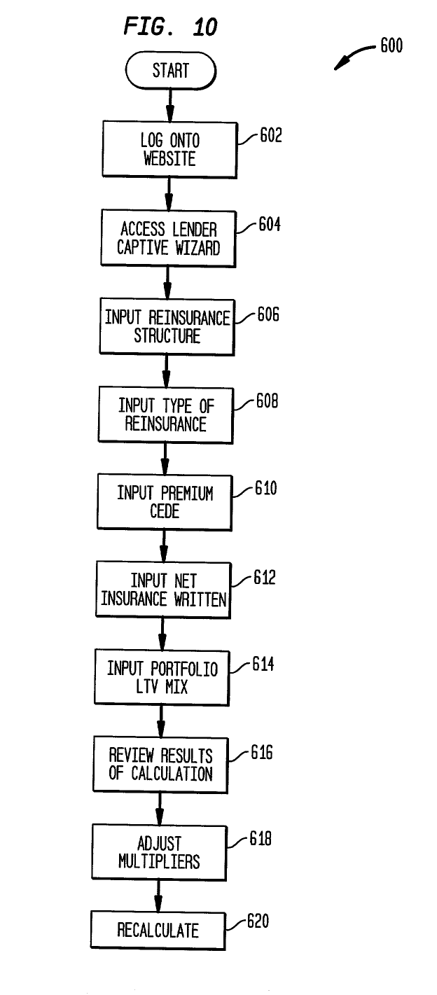

FIG. 10 shows a flowchart of a method 600 according to the invention. In step 602, the customer logs onto a website. In step 604, the customer accesses the lender captive wizard. In step 606, the customer selects the desired reinsurance structure, the type of reinsurance, and the premium cede. In step 608, the customer enters the net insurance written and the portfolio LTV mix. The system then automatically performs the calculation. In step 610, the customer reviews the results of the calculation. In step 612, the customer adjusts the multipliers as needed. The customer then recalculates as many times as desired to explore various assumptions and scenarios.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

1. A system for performing a financial analysis of proposed captive reinsurance options, comprising:
a server computer;
at least one terminal connected into a network with the server computer, the terminal receiving inputs from, and providing outputs to, a user; and
a software module run by the server computer for performing a financial analysis of proposed captive reinsurance options based upon inputs received at the terminal from a user, including reinsurance structure, type of reinsurance, net premium cede, new insurance written and portfolio loan-to-value mix, the terminal displaying results of the financial analysis to the user.

2. The system of claim 1, wherein the software module calculates a gross premium cede and a ceding commission based upon the inputted net premium cede, and wherein the calculated gross premium cede and the ceding commission are displayed at the terminal to the user.

3. The system of claim 1, wherein, if the selected type of reinsurance is excess-of-loss reinsurance, the software module calculates risk tiers, which are displayed at the terminal to the user.

4. The system of claim 3, wherein the calculated risk tiers include first and second attachment points.

5. The system of claim 1, wherein the inputs relating to portfolio loan-to-value mix include percentage allocations of loans in the portfolio to defined loan-to-value categories.

6. The system of claim 1, wherein the software module incorporates assumptions and captive reinsurance product data, which are used in performing the financial analysis.

7. The system of claim 6, wherein the software module provides as a further output displayed at the terminal a list of assumptions upon which the financial analysis is based, including claims rate, prepayment speed, and pre-tax investment rate.

8. The system of claim 7, wherein the terminal receives as an input adjustments to the claims rate, prepayment speed, and pre-tax investment rate, and wherein the software module performs a financial analysis based upon the adjusted values.

9. The system of claim 8, wherein the adjustments to the claims rate, prepayment speed, and pre-tax investment rate are made by inputting a multiplier for each of the claims rate, prepayment speed, and pre-tax investment rate.

10. The system of claim 9, wherein each multiplier is inputted as a percentage, which may be over or under 100 percent.

11. The system of claim 1 further including a website administered by the server computer, the software module being accessed through the website.

12. The system of claim 11 further including an applications programming interface run by the server computer for providing access to a plurality of software modules through the website.

13. A website for performing a financial analysis of proposed captive reinsurance options, comprising:
an analysis web page including a first set of data entry boxes for receiving data inputs relating to proposed captive reinsurance, including reinsurance structure, type of reinsurance, net premium cede, new insurance written and portfolio loan-to-value mix, and
a results web page accessible from the analysis web page setting forth results of a financial analysis performed based upon the inputted data, the results web page including a listing of assumptions upon which the financial analysis is based, including claims rate, prepayment speed, and pre-tax investment rate, and a second set of data entry boxes for receiving adjustments to each of the listed assumptions.

14. The website of claim 13, wherein the results web page displays a summary of the results of the financial analysis, and wherein the website further includes a details web page accessible from the results web page for displaying a detailed version of the results of the financial analysis.

15. The website of claim 13, wherein the website includes a main menu web page providing access to the analysis web page and further providing access to other web pages performing other functions relating to mortgage insurance.

16. A method for performing a financial analysis of proposed captive reinsurance options, comprising:
(a) connecting at least one terminal into a network with a server computer;
(b) running a software module on the server computer to perform a financial analysis of proposed captive reinsurance options based upon inputs received at the terminal from a user, including reinsurance structure, type of reinsurance, net premium cede, new insurance written and portfolio loan-to-value mix;
(c) displaying results of the financial analysis to the user.

17. The method of claim 16, further including:
(d) displaying at the terminal a list of assumptions upon which the financial analysis is based, including claims rate, prepayment speed, and pre-tax investment rate.

18. The method of claim system of claim 7, further including:
(e) receiving at the terminal adjustments to the claims rate, prepayment speed, and pre-tax investment rate, and performing a financial analysis based upon the adjusted values.

19. The method of claim 18, wherein in step (e) the claims rate, prepayment speed, and pre-tax investment rate are adjusted by inputting a multiplier for each of the claims rate, prepayment speed, and pre-tax investment rate.

20. The method of claim 19, wherein each multiplier is inputted as a percentage, which may be over or under 100 percent.
